(19) United States
(12) Patent Application Publication
(10) Pub. No.: US 2008/0206035 A1
(43) Pub. Date: Aug. 28, 2008

(54) LOG SKIDDING APPARATUS

(76) Inventor: Matthew J. Lucco, Cranberry Township, PA (US)

Correspondence Address: MEYER UNKOVIC & SCOTT LLP, 1300 OLIVER BUILDING, PITTSBURGH, PA, 15222, US

(21) Appl. No.: 11/623,762

(22) Filed: Feb. 26, 2007

(51) Int. Cl. B65G 7/02

(52) U.S. Cl. 414/787

(57) ABSTRACT

A log skidding apparatus to be attached to a vehicle, preferably, an all-terrain vehicle. The log skidding apparatus is attached to the vehicle using a rigid tongue and ball coupler. The ball coupler is attached to one end of the rigid tongue, while the other end of the rigid tongue is pivotally attached to the body of the log skidding apparatus. The body of the log skidding apparatus is preferably made of a rigid material and includes at least one cargo holder strategically located to minimize log, load or cargo movement. At least two eyelets are mounted on opposite sides of the top of the base of the log skidding apparatus such that at least one cargo tie-down strap can be used to further secure the log, load or cargo.

### FIELD OF THE INVENTION

The invention generally relates to an apparatus for towing logs or other cargo and more particularly relates to a wheel-less log skidder apparatus for towing logs or other cargo behind a vehicle over rough terrain.

### BACKGROUND OF THE INVENTION

Logs, particularly those of a large diameter, are quite heavy and can present a challenge to a person wishing to move them from one location to another. Even with the use of an all terrain vehicle “ATV” and chain or rope, this task can be burdensome as the front of the log typically penetrates the soil or catches on rocks, stumps or the like during movement, creating significant resistance.

The problems not solved by the related art include the ability to traverse various types of terrain in any season or weather condition and the ability to securely transport a log, or logs, on any degree of incline or decline, without the possibility of the log crashing into the ATV. The related art shows devices that are not compact and easily transportable, for example, devices sold by Berg Equipment, Inc., Future Forestry Products, Inc., NovaJack, and Hud-Son Forest Equipment, Inc. The limitations of the related art are overcome by the present invention.

Most of the related art consists of wheel-based devices, which have a number of disadvantages. These disadvantages include, but are not limited to: (1) the propensity for the wheels to be hindered by rocks, stumps, sticks, ruts, holes or the like that may be in the path of travel; (2) the likelihood for increased resistance during the transport of loads in inclement weather, i.e., snowy, wet or rainy conditions, or in muddy terrain; (3) the potential for axles attached to the wheels to bend or break, thereby rendering the device useless in the field; and, (4) the potential for tires to lose air pressure due to excessive downward force caused by heavy loads or due to punctures made by debris in the exterior wall, thereby rendering the device useless in the field. The present invention achieves the objective of skidding or towing logs or other cargo without the aforementioned disadvantages associated with the related devices.

Further, most of the wheel-based devices are rather large and cumbersome. These devices can be difficult to transport without the aid of a towing vehicle. In the event the device can be maneuvered without a towing vehicle, it is typically done so by two or more individuals. In most cases (e.g. NovaJack, Berg Equipment, Future Forest Products, etc.), the device must be transported from site to site using a medium or large trailer. Due to these size and maneuverability challenges, most of the related art devices are best utilized at a fixed location where travel between sites is not necessary. The present invention is, however, versatile and can be maneuvered easily by one individual. Additionally, transportation of the present invention from site to site does not require a medium or large trailer and can typically be placed in a standard SUV, pick-up truck or other vehicle.

### SUMMARY OF THE INVENTION

The present invention is an apparatus attachable to an ATV or similarly capable machine or vehicle. The typical ATV is provided with a hitch, or a place in which a ball-hitch can be installed. The log skidding apparatus of the present invention is intended to be attached securely to the ATV in a manner that does not require bolts or similar permanent fasteners.

The present invention reduces the resistance created, by a log digging into the soil during towing, by eliminating the contact of the front portion of the log with the soil. Additionally, the present invention avoids the use of wheels, thereby allowing the apparatus to be used over any terrain or in any conditions.

It is therefore an object of the present invention to transport logs or other cargo over terrain using an ATV, or similarly capable machine or vehicle, with the least resistance and greatest ease.

It is a further object of the present invention to attach the present invention securely to an ATV, or similarly equipped machine or vehicle, without the use of permanent fasteners.

Another object of the present invention is to provide a log skidding apparatus capable of functioning in rough terrain and inclement weather conditions.

Another object of the present invention is to provide a log skidding apparatus, with a rigid tongue, which prevents a log or other cargo from contacting the ATV while it is traversing a downward slope.

Yet another object of the present invention is to provide a log skidding apparatus which is rigid and durable.

Yet another object of the present invention is to provide a log skidding apparatus which is easily maneuverable by one person.

Yet another object of the present invention is to provide a log skidding apparatus with a curved, angled or slated front portion to aid in movement while traversing rough terrain.

Still another object of the present invention is to provide a log skidding apparatus capable of transporting long uncut logs, shorter cut logs or other cargo.

Specifically, what is provided is a log skidding apparatus, capable of attachment to a vehicle, comprising a body, having a base and a curved front portion. The base has a top side and bottom side and a front end and rear end. The curved front portion is either integral with the base at the front end or attached to the base at the front end. The apparatus further comprises, a rigid tongue, pivotably attached at one end to the front portion of the base and attached at another end to a ball coupler. The rigid tongue is vertically pivotable about the axis of its attachment at an angle of up to about 250 degrees in a direction towards the top side of the base and up to about 90 degrees in a direction towards the bottom side of the base. A cargo holder is affixed to the top side of the base near the rear end. The cargo holder is a piece of angled material, a piece of material perpendicular to the base, a piece of material angled with respect to the base, a triangular piece, a square piece, a rectangular piece or a trapezoidal piece.

The body of the apparatus further comprises at least two eyelets attached on opposite sides of the top of the base near the rear end. The apparatus further comprises at least one cargo strap for securing cargo to the apparatus by connection to at least two eyelets. The present invention is capable of transporting cargo over rough terrain and inclement weather conditions.

These and other objects and advantages of the present invention will be apparent from a consideration of the following detailed description of the preferred embodiments in conjunction with the appended drawings.

### BRIEF DESCRIPTION OF THE DRAWINGS

FIG. 1 is a perspective view of the log skidding apparatus of the present invention.

FIG. 2 is a side view of the log skidding apparatus of the present invention.

FIG. 3 is an overhead, perspective view of the log skidding apparatus of the present invention.

FIG. 4 is a bottom view of the log skidding apparatus of the present invention.

FIG. 5 is a side view of the log skidding apparatus of the present invention attached to an ATV and loaded with an elongated log.

FIG. 6 is a side perspective view of the log skidding apparatus of the present invention attached to an ATV and loaded with a group of cut logs.

FIG. 7 is a side view of the log skidding apparatus of the present invention illustrating the rigid tongue's range of motion.

### DETAILED DESCRIPTION OF THE PREFERRED EMBODIMENT

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated apparatus, and such further applications of the principles of the invention illustrated herein, as would normally occur to persons skilled in the art to which the invention relates.

While the present invention is generally described as a device for attachment to an ATV to aid in towing logs, it can be used to haul, transport and/or move any other type of cargo. Further, the apparatus can be used with any type of vehicle, including but not limited to, a car, truck, tractor, bulldozer or any other vehicle used for hauling, pulling or towing.

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

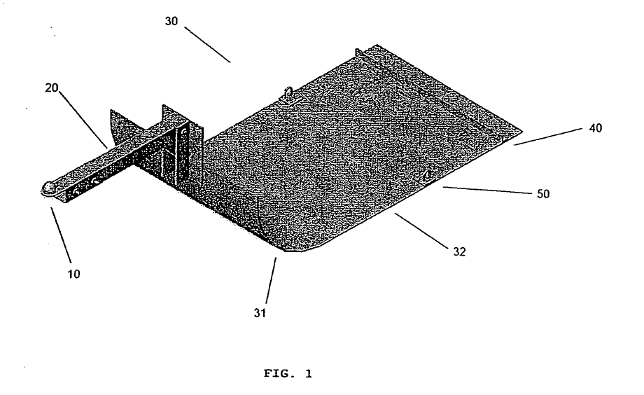

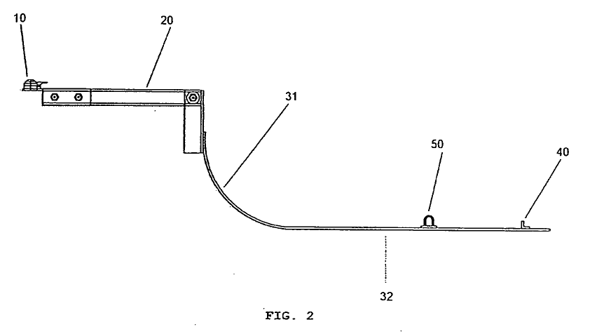

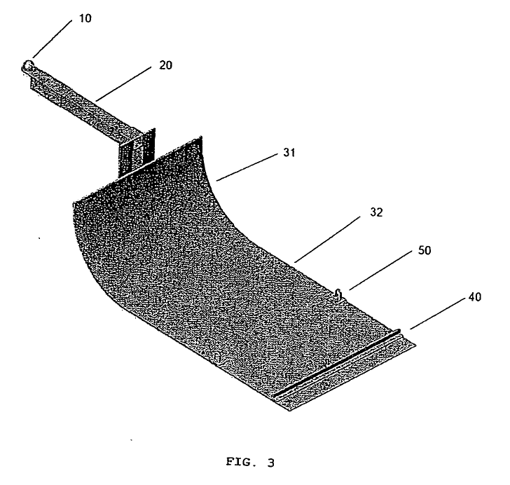

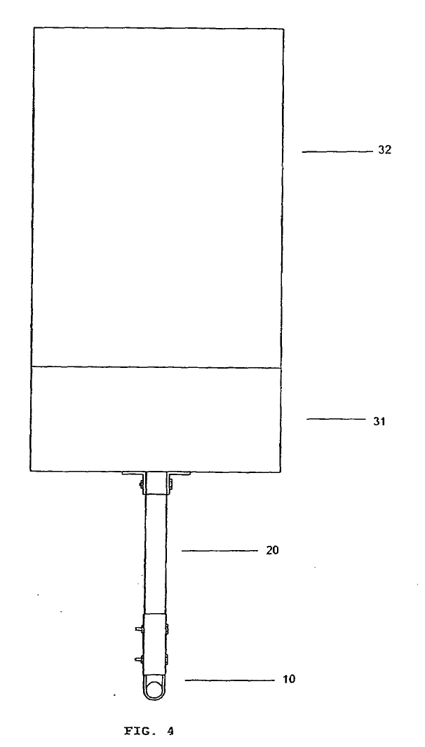

Referring now to FIGS. 1-7, the log skidding apparatus of the present invention, which contains three major components, the ball coupler 10, the tongue 20, and the body 30, is disclosed.

The body 30 of the log skidding apparatus is attached to the ball-hitch of the ATV using the tongue 20 and a ball coupler 10. The tongue 20 is connected to the ball coupler 10 at one end and horizontally and/or vertically pivotably attached to the body 30 of the log skidding apparatus at the other end, preferably by a plate and bracket means (see FIG. 1). The plate and bracket means is attached to the front portion 31 of base 30. The plate and bracket means can be eliminated as long as the rigid tongue 20 is rotateably attached to the front portion 31. The use of a ball hitch and ball coupler 10 provides for a secure attachment such that the log skidding apparatus moves in conjunction with the ATV and cannot become detached or crash into the ATV during travel or sudden stops. While fastened, the ball hitch to ball coupler 10 connection allows the tongue to pivot horizontally with respect to the towing vehicle, thereby allowing for maximum turning capabilities.

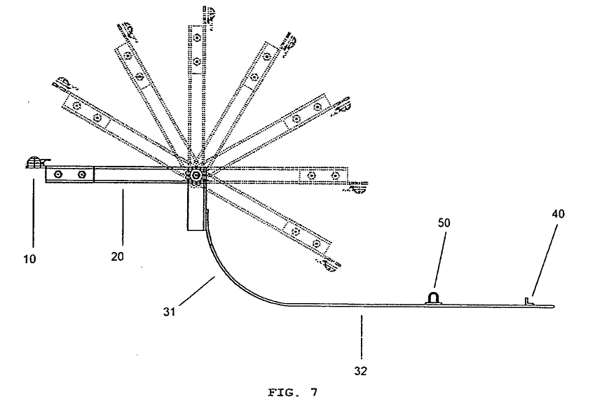

The ball coupler 10 is attached to the tongue 20, the second major component of the log skidding apparatus. The tongue 20 provides a sturdy connection between the ball coupler 10 and the body 30 of the log skidding apparatus (the third major component). Additionally, as illustrated in FIG. 7, the tongue 20 is attached to the body 30 of the apparatus in such a manner that it can vertically pivot on its axis of attachment. This feature has two primary benefits: (1) it allows the device to “float” with the changing terrain, i.e., it allows the towing vehicle or ATV to traverse safely up and down mounds and valleys somewhat independent of the present invention, and (2) it allows the present invention to fold up for ease in storage and transport.

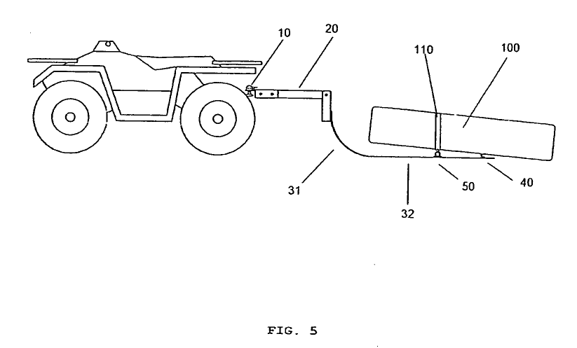

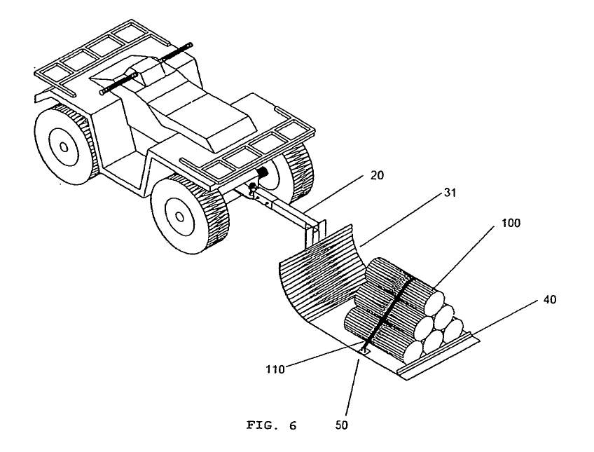

The body 30 of the log skidding apparatus is comprised of a flat, concave or curved base 32 and a front portion 31 attached to or integral with the base 32. The base 32 and front portion 31 can be integral with each other (i.e. one solid piece) or made in two pieces and attached to each other by any means known in the art, including but not limited to, welding or the like. The top of the base 32 is provided with at least two eyelets, hooks or optionally handles 50, one on each side of the base 32, and a cargo holder 40 located opposite the front portion 31. The cargo holder 40 is preferably comprised of metal, hard plastic, steel or like material and can be of varying height and width. The at least two eyelets or hooks 50, in conjunction with at least one tie-down cargo strap 110 are used to secure a log, load of logs or other cargo 100 during transport as illustrated in FIGS. 5 and 6. Four or more eyelets or hooks 50 are also within the scope of this invention. The cargo holder 40 can be attached by any means known in the art, including but not limited to, welding, bolting or the like. Optionally, the cargo holder 40 is removable from the apparatus.

The cargo holder 40 is affixed near the rear end of the base 32 of the log skidding apparatus and prevents the load from shifting backwards or forwards during towing, see for example, FIGS. 5 and 6. While the cargo holder 40 is shown parallel with the rear end of base 32, it can also optionally be diagonal and still function properly. More than one cargo holders 40 can be provided while still being within the scope of the present invention.

The cargo holder 40 also participates in the reduction of transport friction as it assists in the elevation of a log 100. The cargo holder 40 is preferably a piece of angled material, but optionally, can be a piece of material perpendicular to the top side of base 32, a piece of material angled with respect to the top side of the base, a triangular, square, rectangular, trapezoidal or other shaped piece of material and still be within the spirit of the present invention.

Furthermore, the cargo holder 40, in conjunction with at least one tie-down cargo strap 110 affixed to the eyelets or hooks 50 prevents a log or other cargo 100 from shifting backward or forward during transport (see FIG. 5). For purposes of this description, the cargo strap 110 is optionally a chain, a rubber strap or cord, a rope or the like.

The base 32, front portion 31 and cargo holder 40 allow the log skidding apparatus to traverse various types of terrain without being thwarted.

The figures illustrate the curved nature of the front portion 31, which is preferably curved upwards with respect to the top of the base 32. This slope or curvature eliminates the chance for the front of a log, load or other cargo 100 to penetrate the terrain during transport, and thereby increases the efficiency with which the task can be completed. Furthermore, during transport, the front of the log 100 rests on the front of base 32 and the rear of the log 100 rests on either the rear of the base 32 or on the terrain, depending on its length. The log 100 preferably is somewhat elevated, by the cargo holder 40, to minimize contact between the rear surface of the log or other cargo 100 and the terrain, further reducing the friction caused in transport and enhancing the efficiency with which the task can be completed. FIG. 6 further illustrates the versatility of the present invention as it is able to secure and transport a load of cut logs 100.

In one embodiment of the present invention, the front portion 31 of the base 30 is angled between about 30 and about 120 degrees, and more preferably between about 60 and about 100 degrees and most preferably between about 70 and about 95 degrees, with respect to the base 32. The front portion 31 of the body 30, in a preferred embodiment, is curved or semicircular. In another embodiment of the present invention, the front portion 31 is not curved and is situated between about a 20 to about 70 degrees and more preferably between about 30 to about 70 degrees with respect to a horizontal surface or terrain, which effectively deflect impediments.

As may be seen in FIG. 7, the rigid tongue 20 is free to pivot about a vertical axis by which it is connected to the front portion 31 of the body 30. This vertical pivoting encompasses about 90 to about 250 degrees clockwise and about 5 to about 90 degrees counterclockwise, from a horizontal position. This feature allows for a reduction in the space required to store or transport the present invention as its total length can be decreased when not in use. Additionally, this feature allows the device to “float” with the terrain. For example, the towing vehicle may traverse safely up and down mounds and valleys somewhat independent of the log skidding apparatus of the present invention. This feature also increases the safety of the present invention, as a “fixed”, “non-floating” mount would endanger the stability of the towing vehicle on uneven terrain.

The base 32 and front portion 31 of the body 30 of the present invention can be made of any rigid material known in the art, including but not limited to, stainless steel, metal, plate steel, aluminum, wood, hard plastic or the like, or a combination of two or more materials.

During manufacturing, the components of the log skidding apparatus are optionally prepared with a rust inhibitor solution. After the rust inhibitor solution has dried, they are then adequately coated with a primer. Multiple coats can be applied to achieve maximum rust protection. Once the primer has dried, the fabricated components are then adequately coated with a finishing coat, such as paint or other suitable substance. This optional finishing helps in preventing the log skidding device from rusting and helps reduce friction when contacting terrain.

In a preferred embodiment of the present invention, the body 30 of the log skidding device has a length of between about 20 and 100 inches, more preferably between about 30 and about 60 inches and most preferably between about 35 and about 45 inches. The width of the body 30 of the log skidding apparatus is preferably between about 10 and about 60 inches and more preferably between about 15 and about 50 inches and most preferably between about 20 and about 35 inches. Other embodiments of the invention can use longer or shorter lengths or widths and are still within the scope of this invention. Also the length and dimensions of the rigid tongue can be varied and still be within the scope of the present invention.

I claim:

1. A cargo skidding apparatus, capable of attachment to a vehicle, comprising:
a body, having a base and a curved front portion;
wherein said base has a top side and bottom side and a front end and rear end;
a rigid tongue, pivotably attached at one end to said front portion and attached at another end to a ball coupler; and,
a cargo holder affixed to the top side of said base near said rear end;
whereby said apparatus is capable of transporting cargo over rough terrain and in inclement weather conditions.

2. The cargo skidding apparatus of claim 1, wherein said rigid tongue is vertically pivotable about the axis of its attachment at an angle of up to about 250 degrees in a direction towards said top side of said base and up to about 90 degrees in a direction towards said bottom side of said base.

3. The cargo skidding apparatus of claim 1, wherein said body further comprises at least two eyelets attached on opposite sides of said top of said base near the rear end.

4. The cargo skidding apparatus of claim 3, further comprising a cargo strap for securing said cargo to said apparatus by connection to said at least two eyelets.

5. The cargo skidding apparatus of claim 1, wherein said curved front portion is integral with said base at said front end.

6. The cargo skidding apparatus of claim 1, wherein said curved front portion and said base are two separate portions, but connected to each other.

7. The cargo skidding apparatus of claim 1, wherein said cargo holder is selected from the group consisting of a piece of angled material, a piece of material perpendicular to said top of the base, a piece of material angled with respect to said top of the base, a triangular piece, a square piece, a rectangular piece and a trapezoidal piece.

8. An apparatus, capable of attachment to a vehicle, comprising:
a body, having a base and a front portion, wherein said base has a top side and bottom side and a front end and rear end;
a rigid tongue, pivotably attached at one end to said front portion and attached at another end to a ball coupler; and,
wherein said rigid tongue is vertically pivotable about the axis of its attachment at an angle of up to about 250 degrees in a direction towards said top side of said base and up to about 90 degrees in a direction towards said bottom side of said base;
whereby said apparatus is capable of transporting cargo over rough terrain and in inclement weather conditions.

9. The apparatus of claim 8, wherein said body further comprises at least two eyelets attached on opposite sides of the top of said base near the rear end.

10. The apparatus of claim 8, further comprising at least one cargo holder attached to the top side of said base near said rear end.

11. The apparatus of claim 10, wherein said at least one cargo holder is removeably attached to said base.

12. The log skidding apparatus of claim 10, wherein said at least one cargo holder is selected from the group consisting of a piece of angled material, a piece of material perpendicular to said top side of the base, a piece of material angled with respect to the top side of the base, a triangular piece, a square piece, a rectangular piece and a trapezoidal piece.

13. The log skidding apparatus of claim 8, wherein said curved front portion is integral with said base at said front end.

14. The log skidding apparatus of claim 8, wherein said curved front portion and said base are two separate portions, but connected to each other.

15. The apparatus of claim 8, further comprising a cargo strap for securing said cargo to said apparatus by connection to said at least two eyelets.

16. The apparatus of claim 8, wherein said front portion is curved.

17. A log skidding apparatus, capable of attachment to a vehicle, comprising:
a body, having a base and a curved front portion;
wherein said base has a top side and bottom side and a front end and rear end and wherein said curved front portion is integral with said base at said front end;
said front portion has a plate attached thereto;
a rigid tongue, pivotably attached at one end to said plate on said front portion and attached at another end to a ball coupler; and,
wherein said body further comprises at least two eyelets attached on opposite sides of the top of said base near said rear end;
whereby said apparatus is capable of transporting said cargo over rough terrain and in inclement weather conditions.

18. The log skidding apparatus of claim 17, further comprising at least one cargo holder attached to said top side of said base near said rear end.

19. The log skidding apparatus of claim 17, wherein said at least one cargo holder is selected from the group consisting of a piece of angled material, a piece of material perpendicular to the top side of the base, a piece of material angled with respect to the top side of the base, a triangular piece, a square piece, a rectangular piece and a trapezoidal piece.

20. The log skidding apparatus of claim 17, further comprising a cargo strap for securing said cargo to said apparatus by connection to said at least two eyelets.
